(19) United States
(12) Patent Application Publication
(10) Pub. No.: US 2020/0132498 A1
(43) Pub. Date: Apr. 30, 2020

(54) DISPLAY CONTROL DEVICE AND DISPLAY CONTROL METHOD

(71) Applicant: Mitsubishi Electric Corporation, Tokyo (JP)

(72) Inventor: Satoshi MATSUMARU, Tokyo (JP)

(73) Assignee: Mitsubishi Electric Corporation, Tokyo (JP)

(21) Appl. No.: 16/613,319

(22) PCT Filed: Jul. 21, 2017
(86) PCT No.: PCT/JP2017/026402

§ 371 Date: Nov. 13, 2019

(51) Int. Cl. G01C 21/36; G08G 1/0969

(52) U.S. Cl. CPC G01C 21/3658; G08G 1/0969

(57) ABSTRACT

It is an object of the present invention to provide a display control device that displays a plurality of trafficable lanes on which a vehicle can travel, on a road displayed on a map showing a route to a destination. The display control device includes a trafficable lane determination unit for determining one or more trafficable lanes which are lanes on which the vehicle can travel on the basis of information on a lane of a road and a route to a destination of the vehicle and a control unit for causing a display unit to display thereon the plurality of trafficable lanes determined by the trafficable lane determination unit, with respect to all lanes included in a road to be displayed on the display unit.

### TECHNICAL FIELD

The present invention relates to a display control device and a display control method.

### BACKGROUND ART

Assuming that a navigation system performs a route guidance on a lane-by-lane basis, it is considered that route guidance information can be provided to a user when the navigation system displays a route on which his vehicle should travel, on only one lane among a plurality of lanes constituting a road.

### PRIOR ART DOCUMENTS

### Patent Documents

[Patent Document 1] Japanese Patent Application Laid Open Gazette No. 2011-154003

[Patent Document 2] Japanese Patent Application Laid Open Gazette No. 2001-272240

### SUMMARY

### Problem to be Solved by the Invention

Such a route indication, however, restricts a lane on which the user can travel and therefore vehicles concentrate to the one guided lane, and as a result, this causes a traffic jam. Further, there is a possibility that the user may think that he must not travel on any other lane than the one lane, and this increases the stress of the user.

Patent Document 1 and Patent Document 2 each disclose a navigation device that displays guidance information for each lane at an intersection. When a spot where the self-vehicle currently travels is located near to an intersection to be guided, i.e., a guidance-target intersection, the navigation device disclosed in Patent Documents 1 and 2 performs a route indication paying attention to a guide from the spot where the self-vehicle travels to the guidance-target intersection. For this reason, the guidance information for each lane is provided only in a narrow display range, i.e., at the intersection that is part of a route to a destination. The user cannot check route information for each lane at any spot other than the guidance-target intersection.

The present invention is intended to solve such problems as above, and it is an object of the present invention to provide a display control device that displays a plurality of trafficable lanes on which a vehicle can travel, on a road displayed on a map showing a route to a destination.

### Means to Solve the Problem

The present invention is intended for a display control device for causing a display unit which is movable together with a vehicle to display thereon a lane on which the vehicle can travel. According to the present invention, the display control device includes a trafficable lane determination unit for determining one or more trafficable lanes which are lanes on which the vehicle can travel on the basis of information on a lane of a road and a route to a destination of the vehicle and a control unit for causing the display unit to display thereon the plurality of trafficable lanes determined by the trafficable lane determination unit, with respect to all lanes included in a road to be displayed on the display unit.

### Effects of the Invention

According to the present invention, it is possible to provide a display control device that displays a plurality of trafficable lanes on which a vehicle can travel, on a road displayed on a map showing a route to a destination. Since a user is provided with a plurality of options, for example, as to lanes on which his vehicle can travel, this easily causes a situation where a plurality of vehicles traveling in the same direction may travel, being distributed to the plurality of trafficable lanes.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing an exemplary constitution of a display control device in accordance with a first preferred embodiment;

FIG. 2 is a flowchart showing an exemplary display control method performed by the display control device in accordance with the first preferred embodiment;

FIG. 3 is a block diagram showing an exemplary constitution of a display control device and a navigation system in accordance with a second preferred embodiment;

FIG. 4 is a block diagram showing an exemplary hardware constitution of the navigation system in accordance with the second preferred embodiment;

FIG. 5 is a view showing an exemplary processing circuit included in the display control device in accordance with the second preferred embodiment;

FIG. 6 is a view showing another exemplary processing circuit included in the display control device in accordance with the second preferred embodiment;

FIG. 7 is a view showing an exemplary data structure of map information in accordance with the second preferred embodiment;

FIG. 8 is a view showing an exemplary data structure of road network data in accordance with the second preferred embodiment;

FIG. 9 is a view showing respective examples of a road, a road link, and a lane link in accordance with the second preferred embodiment;

FIG. 10 is a flowchart showing an exemplary method of generating trafficable lane information in accordance with the second preferred embodiment;

FIG. 11 is a flowchart showing an exemplary method of generating route direction information in accordance with the second preferred embodiment;

FIG. 12 is a flowchart showing an exemplary method of determining a trafficable lane in accordance with the second preferred embodiment;

FIG. 13 is a schematic view showing lane types and a road in accordance with the second preferred embodiment;

FIG. 14 is a flowchart showing an exemplary method of generating travel recommended lane information in accordance with the second preferred embodiment;

FIG. 15 is a flowchart showing an exemplary method of determining a travel recommended lane in accordance with the second preferred embodiment;

FIG. 16 is a flowchart showing an exemplary method of determining a lane change in accordance with the second preferred embodiment;

FIG. 17 is a view showing an inclusion relation of the trafficable lane and the travel recommended lane in accordance with the second preferred embodiment;

FIG. 18 is a flowchart showing an exemplary display control method of route guidance information in accordance with the second preferred embodiment;

FIG. 19 is a flowchart showing an exemplary method of acquiring route information in accordance with the second preferred embodiment;

FIG. 20 is a flowchart showing an exemplary control method for displaying the route information in accordance with the second preferred embodiment;

FIG. 21 is a view showing an exemplary map including a route guidance display in accordance with the second preferred embodiment;

FIG. 22 is a view showing another exemplary map including a route guidance display in accordance with the second preferred embodiment;

FIG. 23 is a view showing still another exemplary map including a route guidance display in accordance with the second preferred embodiment;

FIG. 24 is a view showing an exemplary map including a display of a lane change recommendation section in accordance with the second preferred embodiment;

FIG. 25 is a flowchart showing an exemplary method of re-searching and redisplaying a route in accordance with the second preferred embodiment;

FIG. 26 is a view showing exemplary display states of the travel recommended lane and the trafficable lane in accordance with the second preferred embodiment; and

FIG. 27 is a block diagram showing another exemplary constitution of the display control device and the navigation system in accordance with the second preferred embodiment.

### DESCRIPTION OF EMBODIMENTS

### The First Preferred Embodiment

A display control device and a display control method in accordance with the first preferred embodiment will be described.

FIG. 1 is a block diagram showing an exemplary constitution of a display control device 100 in accordance with the present preferred embodiment. A display unit 20 is movable together with a vehicle and displays route guidance information to a destination of the vehicle on a map. The display control device 100 causes the display unit 20 to display thereon a lane on which the vehicle can travel.

A trafficable lane determination unit 1 determines one or more trafficable lanes on a road constituting a route to the destination of the vehicle on the basis of information on a lane of a road and the route. The trafficable lane is a lane which is determined by the display control device 100 as a lane on which a user easily travel on the route to the destination. The trafficable lane is, for example, a lane which is determined on the route to the destination on the basis of on the respective numbers of right turns, left turns, straight-ahead travels, and lane changes, the distance to an intersection or the like where the right turn, the left turn, the straight-ahead travel, or the lane change is performed, traffic regulations, or the like. Herein, the intersection or the like refers to an intersection, a branch lane, a merging lane, or the like.

A system control unit 2 causes the display unit 20 to display thereon a plurality of trafficable lanes determined by the trafficable lane determination unit 1 with respect to all lanes included in the road to be displayed on the display unit 20.

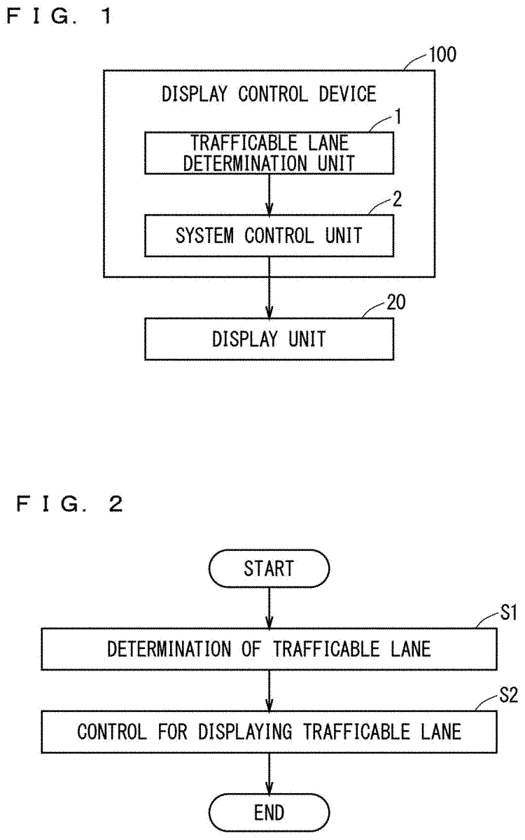

FIG. 2 is a flowchart showing an exemplary display control method performed by the display control device 100.

In Step S1, the trafficable lane determination unit 1 determines one or more trafficable lanes on a route to a destination of a vehicle on the basis of information on a lane of a road and the route. In the first preferred embodiment, the information on the lane of the road is included in map data, but not limited to this. The route to the destination is included in information on routes which have been searched for in advance. Specifically, the trafficable lane determination unit 1 acquires the map data including the information on the lanes and the information on the routes which have been searched for and uses the map data and the information to determine the trafficable lane.

In Step S2, the system control unit 2 displays the trafficable lanes determined in Step S1 with respect to all the lanes included in the roads to be displayed on the display unit 20. Specifically, the system control unit 2 performs a control to cause the display unit 20 to display thereon the trafficable lanes. At that time, in a case where the road consists of one lane, the system control unit 2 displays the one lane, and in a case where the road consists of two or more lanes and a plurality of trafficable lanes are determined, the system control unit 2 displays the plurality of trafficable lanes. Through Steps S1 and S2 described above, a route including the plurality of trafficable lanes is displayed on the display unit 20.

The display control device 100 can display a plurality of trafficable lanes on which the vehicle can travel, on the map showing the route to the destination, and provide a plurality of options as to the lane on which the user will travel. As a result, there is an increased possibility that a plurality of vehicles traveling in the same direction may travel, being distributed to the plurality of trafficable lanes, and occurrence of a traffic jam or the like can be reduced. Further, the display control device 100 uses the information on the route to the destination, which has been already searched for, to determine and display the trafficable lanes. For this reason, the display control device 100 can display the trafficable lanes on all the routes, not only at a spot which is part of the routes to the destination, such as the intersection, the branch lane, the merging lane, or the like. This is convenient since the user can check the route for each lane at any spot. Furthermore, the display control device 100 can reduce the system load, as compared with a display method accompanied by the route search.

### The Second Preferred Embodiment

A display control device and a display control method in accordance with the second preferred embodiment will be described.

(Constitution)

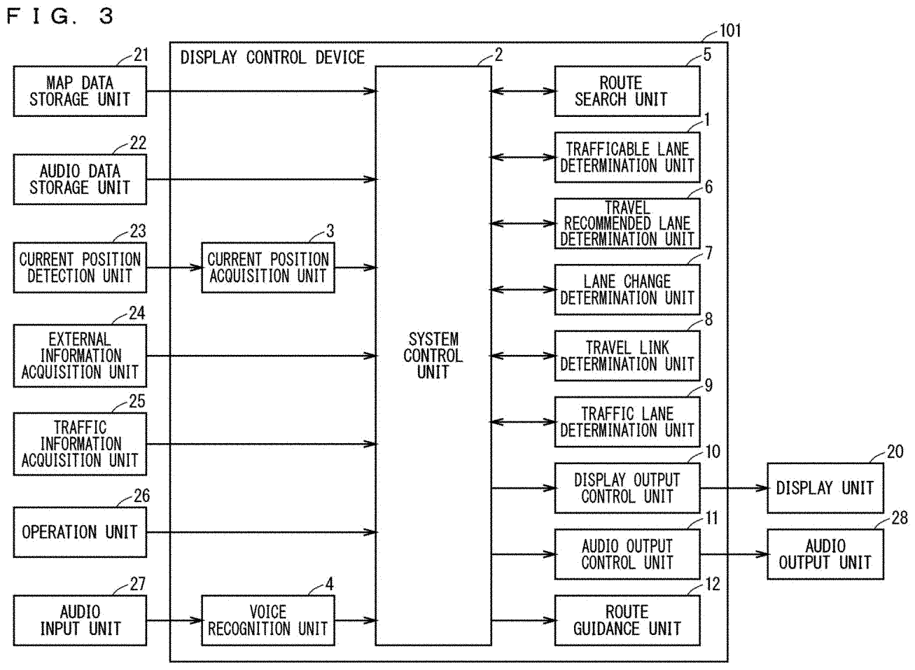

FIG. 3 is a block diagram showing an exemplary constitution of a display control device 101 and a navigation system in accordance with the second preferred embodiment. Besides the display control device 101, the navigation system includes a map data storage unit 21, an audio data storage unit 22, a current position detection unit 23, an external information acquisition unit 24, a traffic information acquisition unit 25, an operation unit 26, an audio input unit 27, the display unit 20, and an audio output unit 28. In the second preferred embodiment, the navigation system is mounted on a vehicle. The map data storage unit 21 and the audio data storage unit 22, however, may be provided outside the vehicle, instead of being mounted on the vehicle, as described later.

The map data storage unit 21 stores map data. The display control device 101 acquires the whole of or part of the map data from the map data storage unit 21 to determine the trafficable lane or a travel recommended lane described later. Though the details of the map data will be described later, the map data includes road network data that is road information, lane link information that corresponds to the information on the lane of the road, a lane type, or the like.

The audio data storage unit 22 stores audio guide messages for guiding the vehicle traveling on the road, as audio data. The audio guide messages are stored, being separated into a standard voice and a word voice. The standard voice is stored for each type of audio guide. The word voice is stored, including specific values representing a distance, a place name, or the like. The navigation system combines the standard voice and the word voice to provide a desired voice to the user.

The map data storage unit 21 and the audio data storage unit 22 may be mounted on the vehicle by being included in the display control device 101 or may be provided in a storage device outside the display control device 101, a server device outside the vehicle, or the like. In a case where the map data storage unit 21 and the audio data storage unit 22 are provided outside the vehicle, the display control device 101 acquires the map data and the audio data from the map data storage unit 21 and the audio data storage unit 22, respectively, via a communication network.

The current position detection unit 23 detects a current position of the vehicle. The current position detection unit 23 uses, for example, position information received from a GNSS (Global Navigation Satellite System) receiver or information detected from output data of various sensors, to detect the current position.

The external information acquisition unit 24 acquires information around the vehicle, such as white line information on a traveling road, or information outside the vehicle, such as a road sign, an obstacle, or the like. The external information acquisition unit 24 is formed of an external sensor. The external sensor includes, for example, a front camera provided to be capable of imaging an area in a traveling direction of the vehicle, i.e., a front area thereof, a rear camera provided to be capable of imaging a rear area of the vehicle, a laser radar, or the like.

The traffic information acquisition unit 25 receives and acquires traffic information from the outside.

The operation unit 26 is operated by the user, and with this operation, the user gives information or instructions to the navigation system. The user operates the operation unit 26 to, for example, input the destination during the route search or give the display control device 101 various instructions such as a change of a screen to be displayed on the display unit 20, or the like.

The audio input unit 27 receives a voice from the user. The user can give information or instructions to the navigation system by using the audio input unit 27.

The display control device 101 includes a current position acquisition unit 3, a voice recognition unit 4, a route search unit 5, a trafficable lane determination unit 1, a travel recommended lane determination unit 6, a lane change determination unit 7, a travel link determination unit 8, a traffic lane determination unit 9, a system control unit 2, a display output control unit 10, an audio output control unit 11, and a route guidance unit 12.

The current position acquisition unit 3 acquires a current position of the vehicle, which is detected by the current position detection unit 23.

The voice recognition unit 4 checks the voice inputted by the audio input unit 27 by consulting a dictionary for voice recognition to recognize the voice and gives an instruction in accordance with the recognized voice to the system control unit 2 described later.

The route search unit 5 searches for a route to the destination on the basis of the map data acquired from the map data storage unit 21 and stores the route which is found. Further, when the current position of the vehicle which is determined by the traffic lane determination unit 9 described later is not positioned within the trafficable lane, the route search unit 5 searches for a new route from the current position of the vehicle to the destination. The route which is searched for by the route search unit 5 includes, for example, a time priority route, a distance priority route, a fuel priority route, a toll road priority route, a general road priority route, a standard route, or the like. The time priority route is a route that makes it possible to reach the destination within a short time of arrival. The distance priority route is a route having a short travel distance to the destination. The fuel priority route is a route that makes it possible to reach the destination with less fuel to be consumed. The toll road priority route is a route on which a toll road is preferentially selected to travel. The general road priority route is a route on which a general road is preferentially selected to travel. The standard route is a route with a good balance of time, distance, and cost.

The trafficable lane determination unit 1 determines one or more trafficable lanes on the basis of information on a lane of a road and the route to the destination of the vehicle. In the second preferred embodiment, the information on the lane of the road is included in the map data and is a lane type included in the lane link information as specifically described later. The map data is acquired from the map data storage unit 21. Further, the route to the destination is a route which has been searched for in advance by the route search unit 5.

The travel recommended lane determination unit 6 determines a travel recommended lane included in the plurality of trafficable lanes determined by the trafficable lane determination unit 1 on the basis of the information on the lane of the road and the route to the destination of the vehicle. The travel recommended lane is a lane which consists of one or more trafficable lanes among the plurality of trafficable lanes on the route to the destination and is determined by the display control device 100 as a lane on which the user most easily travel and recommended to the user to travel thereon. The travel recommended lane is, for example, a lane which passes one or more trafficable lanes and is determined on the basis of the respective numbers of right turns, left turns, straight-ahead travels, and lane changes, the distance to an intersection or the like where the right turn, the left turn, the straight-ahead travel, or the lane change is performed, traffic regulations, or the like. For example, a lane with the smallest number of lane changes, among the plurality of trafficable lanes, is determined as the travel recommended lane.

The lane change determination unit 7 determines whether or not the travel recommended lane constituting the route to the destination includes a place requiring a lane change.

The travel link determination unit 8 specifies a road link on which the vehicle travels, i.e., a travel link on the basis of the current position acquired by the current position acquisition unit 3 and road data included in the map data acquired from the map data storage unit 21. Further, detailed description of the road link will be made later.

The traffic lane determination unit 9 determines a traffic lane on which the vehicle travels on the travel link specified by the travel link determination unit 8, on the basis of the lane link information included in the map data and various sensor information or external information. In the present preferred embodiment, particularly, the traffic lane determination unit 9 determines whether or not the current position of the vehicle is positioned within the trafficable lane.

The system control unit 2 causes the display unit 20 to display thereon the trafficable lanes with respect to all the lanes included in the road to be displayed on the display unit 20. Further, the system control unit 2 causes the display unit 20 to display thereon the travel recommended lane with respect to at least one lane included in the road to be displayed on the display unit 20. Furthermore, the system control unit 2 displays a lane change recommendation section consisting of a plurality of travel recommended lanes having portions adjacent to one another in the place requiring the lane change on the basis of a result of the lane change determination unit 7. The system control unit 2 causes the display unit 20 to display thereon the trafficable lane and the travel recommended lane in different visibility states. In the present preferred embodiment, the system control unit 2 controls the display output control unit 10 described later, to thereby implement the above-described functions.

Further, the system control unit 2 controls an overall operation of the navigation system. The system control unit 2 controls the whole system by, for example, reading out necessary data from the map data storage unit 21 or the audio data storage unit 22 or capturing the current position of the vehicle from the current position detection unit 23 through the current position acquisition unit 3.

The display output control unit 10 controls the display unit 20 in accordance with an instruction from the system control unit 2. The display output control unit 10 generates a display signal to display the route guidance information including a road map, a current position mark, a destination mark, the trafficable lane, the travel recommended lane, the lane change recommendation section, or the like and outputs the display signal to the display unit 20.

The audio output control unit 11 controls the audio output unit 28 in accordance with an instruction from the system control unit 2. The audio output control unit 11 generates an audio signal including the route guidance information or the like and outputs the audio signal to the audio output unit 28.

The route guidance unit 12 performs a control to give guidance along the route calculated by the route search unit 5 by using the display unit 20 or the audio output unit 28 and guides the vehicle to the destination.

The display unit 20 accepts the display signal outputted from the display output control unit 10 and displays thereon the route to the destination or information around the route, i.e., the route guidance information on the basis of the display signal.

The audio output unit 28 accepts the audio signal outputted from the audio output control unit 11 and gives, for example, the route guidance information to the destination with the audio guide message.

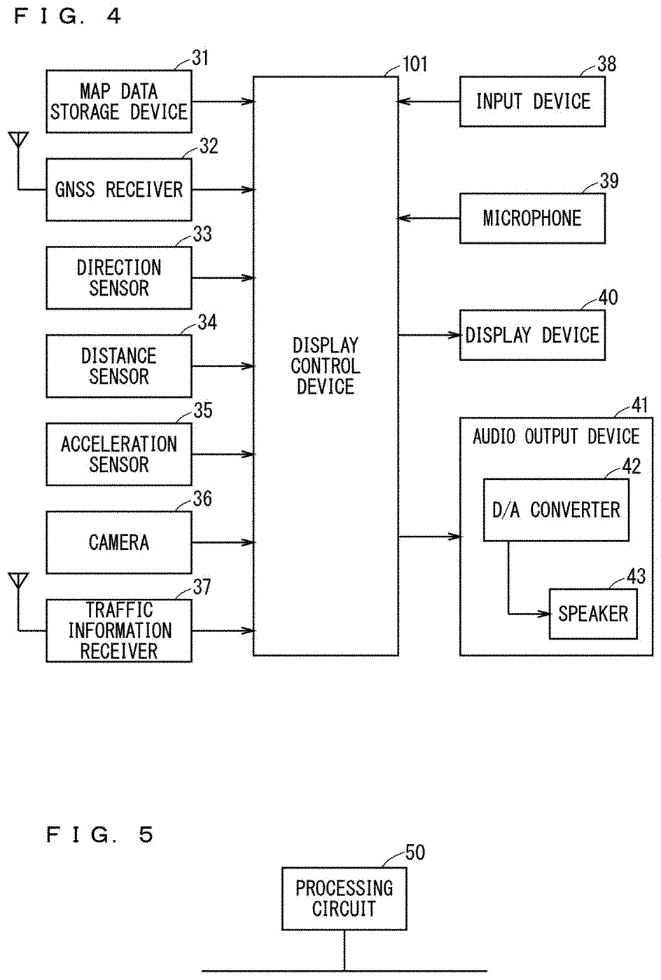

FIG. 4 is a block diagram showing an exemplary hardware constitution of the navigation system in accordance with the present preferred embodiment.

The hardware configuration of the navigation system includes a map data storage device 31, a GNSS receiver 32, a direction sensor 33, a distance sensor 34, an acceleration sensor 35, a camera 36, a traffic information receiver 37, an input device 38, a microphone 39, the display control device 101, a display device 40, and an audio output device 41.

The map data storage device 31 is formed of a storage device such as a HDD (Hard Disk Drive), a DVD (Digital Versatile Disc) which is a recording medium and a DVD drive unit, a semiconductor memory, or the like. The map data storage device 31 corresponds to the map data storage unit 21 and the audio data storage unit 22 shown in FIG. 1.

The GNSS receiver 32 receives a radio wave transmitted from a GPS (Global Positioning System) satellite or the like and measures the current position of the vehicle in which the GNSS receiver 32 is set. The GNSS receiver 32 outputs a positioning result such as a position, a direction, a speed, or the like to the display control device 101. The direction sensor 33 outputs an angular velocity at every predetermined cycle and detects a direction of the vehicle on the basis thereof. The distance sensor 34 outputs a pulse signal in accordance with a travel distance of the vehicle and detects the travel distance of the vehicle on the basis of the pulse signal. The acceleration sensor 35 detects an acceleration in a sensor coordinate system at every predetermined cycle. Each of these sensors outputs the detected result to the display control device 101. The GNSS receiver 32, the direction sensor 33, the distance sensor 34, and the acceleration sensor 35 correspond to the current position detection unit 23 shown in FIG. 1.

The camera 36 captures an image of the surroundings of the vehicle. The captured image data is image-processed by the display control device 101 and information on the things outside the vehicle is thereby acquired. The camera 36 corresponds to the external information acquisition unit 24 shown in FIG. 1.

The traffic information receiver 37 is an FM multiplex receiver, a beacon receiver, a TMC (Traffic Message Channel) receiver, or the like for receiving the traffic information. The traffic information receiver 37 corresponds to the traffic information acquisition unit 25 shown in FIG. 1.

The input device 38 is a remote control, a touch switch, or the like. The input device 38 corresponds to the operation unit 26 shown in FIG. 1.

The microphone 39 is used for the user to input his voice. The microphone 39 corresponds to the audio input unit 27 shown in FIG. 1.

To the display control device 101, inputted are the map data and the audio data from the map data storage device 31, the information on the current position from the GNSS receiver 32, the direction sensor 33, the distance sensor 34, or the acceleration sensor 35, and the information on the things outside the vehicle from the camera 36. Further, the instructions from the user are inputted to the display control device 101 from the input device 38 or the microphone 39.

The display control device 101 processes the data, the information, or the instructions that are inputted by using a processing circuit described later, to thereby generate the route guidance information, and outputs the route guidance information to the display device 40 and the audio output device 41. When the display control device 101 outputs the route guidance information to the display device 40, the display control device 101 outputs a display signal to display the trafficable lane, the travel recommended lane, or the lane change recommendation section on the display device 40. When the display control device 101 outputs the route guidance information to the audio output device 41, the display control device 101 outputs digital signal data including the audio guide message.

The display device 40 is formed of, for example, a liquid crystal display or an HUD (head up display). On the display device 40, displayed is the route guidance information based on the display signal outputted from the display control device 101. The display device 40 corresponds to the display unit 20 shown in FIG. 1.

The audio output device 41 is constituted of a digital-to-analog converter 42 (D/A converter 42) for converting the audio guide message included in the digital signal data outputted from the display control device 101 into an analog signal, an amplifier for amplifying the voice which is converted into the analog signal, and a speaker 43 for outputting the amplified voice. The audio output device 41 corresponds to the audio output unit 28 shown in FIG. 1.

FIG. 5 is a view showing an exemplary processing circuit 50 included in the display control device 101. Respective functions of the current position acquisition unit 3, the route search unit 5, the trafficable lane determination unit 1, the travel recommended lane determination unit 6, the lane change determination unit 7, the traffic lane determination unit 9, and the system control unit 2 are implemented by the processing circuit 50. In other words, the processing circuit 50 includes the current position acquisition unit 3, the route search unit 5, the trafficable lane determination unit 1, the travel recommended lane determination unit 6, the lane change determination unit 7, the traffic lane determination unit 9, and the system control unit 2. Further, respective functions of the voice recognition unit 4, the travel link determination unit 8, the display output control unit 10, the audio output control unit 11, and the route guidance unit 12 which are included in the display control device 101 are also implemented by the processing circuit 50.

When the processing circuit 50 is a dedicated hardware, the processing circuit 50 corresponds to, for example, a single circuit, a complex circuit, a programmed processor, a multiple programmed processor, an ASIC (Application Specific Integrated Circuit), an FPGA (Field Programmable Gate Array), a combination of these circuits, or the like. The respective functions of the current position acquisition unit 3, the route search unit 5, the trafficable lane determination unit 1, the travel recommended lane determination unit 6, the lane change determination unit 7, the traffic lane determination unit 9, and the system control unit 2 may be individually implemented by a plurality of processing circuits, or these functions may be collectively implemented by one processing circuit.

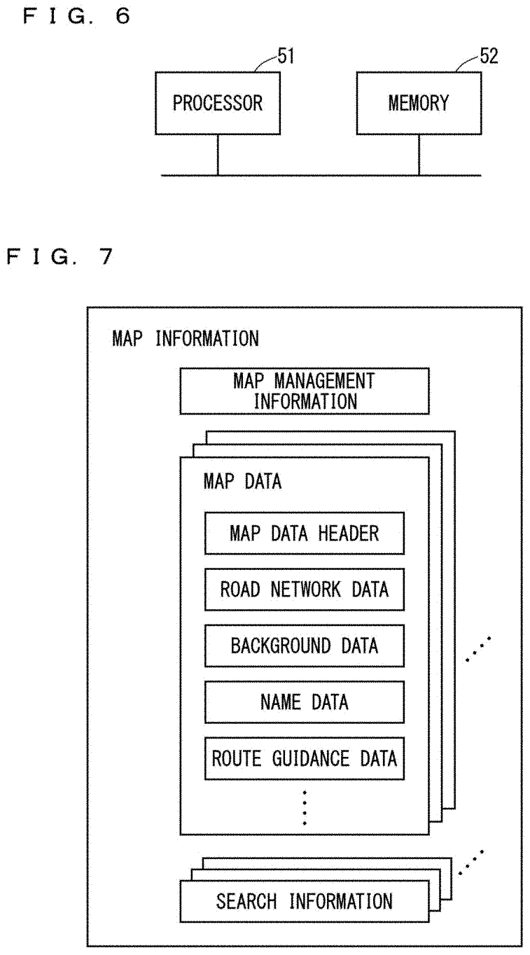

FIG. 6 is a view showing another exemplary processing circuit included in the display control device 101. The processing circuit shown in FIG. 6 includes a processor 51 and a memory 52. The processor 51 executes a program stored in the memory 52, to thereby implement the respective functions of the current position acquisition unit 3, the route search unit 5, the trafficable lane determination unit 1, the travel recommended lane determination unit 6, the lane change determination unit 7, the traffic lane determination unit 9, and the system control unit 2. For example, software or firmware described as the program is executed by the processor 51 and the respective functions are thereby implemented. In other words, the display control device 101 includes the memory 52 for storing therein the program to determine one or more trafficable lanes which are lanes on which the vehicle can travel on the basis of information on a lane of a road and the route to the destination of the vehicle and to cause the display unit 20 to display thereon the trafficable lane determined as the lane on which the vehicle can travel, with respect to all the lanes included in the road to be displayed on the display unit 20, and the processor 51 for executing the program. The program is executed to cause a computer to perform a procedure or a method of the current position acquisition unit 3, the route search unit 5, the trafficable lane determination unit 1, the travel recommended lane determination unit 6, the lane change determination unit 7, the traffic lane determination unit 9, and the system control unit 2.

The processor 51 is, for example, a CPU (Central Processing Unit), a processing unit, an arithmetic unit, a microprocessor, a microcomputer, a DSP (Digital Signal Processor), or the like. The memory 52 is, for example, a nonvolatile or volatile semiconductor memory such as a RAM (Random Access Memory), a ROM (Read Only Memory), a flash memory, an EPROM (Erasable Programmable Read Only Memory), an EEPROM (Electrically Erasable Programmable Read Only Memory), or the like. Alternatively, the memory 52 may be every storage medium to be used in the future such as a magnetic disk, a flexible disk, an optical disk, a compact disk, a mini disk, a DVD, or the like. In the present preferred embodiment, as one example, the display control device 101 includes the CPU, the ROM, and the RAM. The ROM is a memory to be used as a main storage of the CPU, and the RAM is a memory for storing therein a control program or the like.

There may be a case where some part of the above-described respective functions of the current position acquisition unit 3, the route search unit 5, the trafficable lane determination unit 1, the travel recommended lane determination unit 6, the lane change determination unit 7, the traffic lane determination unit 9, and the system control unit 2 is implemented by a dedicated hardware and the other part is implemented by software or firmware. Thus, the processing circuit can implement the above-described functions by hardware, software, firmware, or combination thereof.

FIG. 7 is a view showing an exemplary data structure of map information stored in the map data storage unit 21.

The map information includes map management information, the map data, and search information.

The map management information includes, for example, version information indicating the version of the map information, hierarchical management information for managing the hierarchy used to associate a plurality of pieces of map data having different scales on a scale basis, to be stored, and search management information for managing various search information. In each hierarchy, the map data are divided into a plurality of meshes. The hierarchical management information has information such as a mesh number corresponding to each mesh, a storage location of the map data, data size, or the like for each hierarchy.

The map data includes a map data header, road network data, background data, name data, route guidance data, or the like. The map data header includes information to manage each data in the map data. The road network data includes the above-described road information, i.e., information on a road network. The road network is represented by using a node representing an intersection on the road, a branch, or a spot on the road, a road link representing a road connecting two nodes, and a lane (lanes) constituting the road. The background data includes plane data representing a river, a sea, or the like, line data representing a river, a railroad, or the like each of which is linear, and point data representing a facility symbol or the like. The name data includes road name information representing a road name, place name information representing a place name, and background name information representing a name of a river, a sea, a facility symbol, or the like. The route guidance data includes information required for route guidance at an intersection or the like. Further, the map data is hierarchized in accordance with the degree of details of the information.

The search information is provided for each type of information to be searched for. The search information includes information used to search for various information on a city, a road, a facility, an address, a phone number, an intersection, or the like.

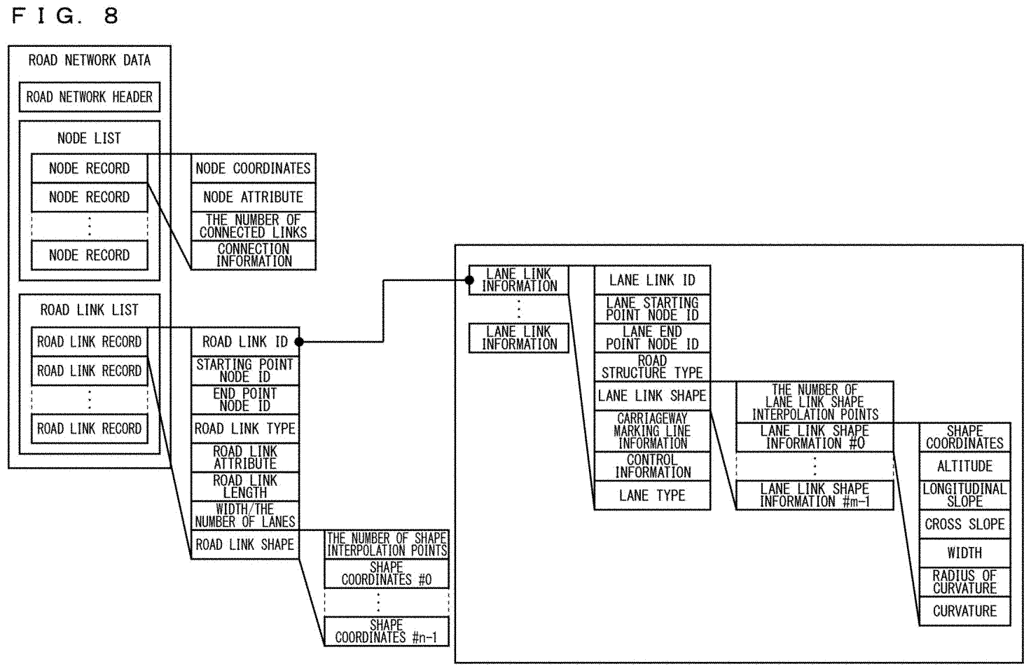

FIG. 8 is a view showing an exemplary data structure of the road network data in one mesh included in the map information of FIG. 7.

The road network data includes a road network header, a node list, a road link list.

The road network header includes information required to manage the road network data. The information includes the number of nodes and the number of road links which are present in one mesh, the number of ID management records, a storage location and data size of each list, a storage location and data size of each table, or the like.

The node list is data on a plurality of nodes which are present in the mesh. The node list is constituted of a plurality of node records corresponding to a plurality of nodes, respectively. To each of the node records, given is a node ID corresponding to the alignment sequence in the node list. The node ID is in one-to-one correspondence with each node in the mesh and used to identify each node in the mesh.

Each node record includes node coordinates, a node attribute, the number of connected links, connection information, or the like. The node coordinates represent a geographic location of each node, and the geographic location is represented by the longitude and latitude. The node attribute indicates whether each node is an intersection or a boundary node, or the like. The number of connected links indicates the number of road links connected to each node. The connection information indicates a link ID of the road link connected to each node in the mesh.

The road link list is data on a plurality of road links which are present in the mesh. The road link list is constituted of a plurality of road link records corresponding to the plurality of road links, respectively.

Each of the road link records includes a road link ID, a starting point node ID, an end point node ID, a road link type, a road link attribute, a road link length, the width and the number of lane, and a road link shape. The road link ID is an ID to identify each road link in the mesh. The starting point node ID is an ID to identify a starting point node which is a starting point of each road link. The end point node ID is an ID to identify an end point node which is an end point of each road link. The road link type represents a type of each road link. The road link attribute represents any one of various attributes of each road link, such as a road type, an average travel time, traffic restrictions, a speed limit, or the like. The road link length represents the length of each road link. The width and the number of lanes represent the width and the number of lanes of each road link. The road link shape represents a road shape of each road link, though details thereof will be described later.

The road link shape includes the number of shape interpolation points and a shape coordinates list.

The number of shape interpolation points represents the number of shape interpolation points which are vertices of the road shape of each road link that is represented by a polygonal line. The shape interpolation point does not include a starting point node or an end point node. In a case where the road shape is a straight line connecting the starting point node and the end point node, for example, the number of shape interpolation points is “0”.

The shape coordinates list is a list in which the coordinates of the shape interpolation points which are vertices of the polygonal line representing the road shape of each road link, i.e., shape coordinates are aligned. The shape coordinates are coordinates representing the geographic location by using the longitude and latitude. The shape coordinates may be represented by the relative longitude and latitude with the shape interpolation point positioned next thereto as a reference. At that time, the shape coordinates of the first shape interpolation point are represented by the relative longitude and latitude with the starting point node of the road link as a reference. Further, the road link shape may be represented by an interpolation line which is a polygonal line connecting the shape interpolation points, instead of the shape interpolation points

Furthermore, the road network data includes a plurality of pieces of lane link information corresponding to each road link ID.

Each of the pieces of lane link information includes a lane link ID, a lane starting point node ID, a lane end point node ID, a road structure type, a lane link shape, carriageway marking line information, control information, a lane type.

The lane link ID is set for each of a plurality of lane links constituting each road link and an ID to identify each lane link. The lane starting point node ID is an ID to identify the starting point node which is the starting point of each lane link. The lane end point node ID is an ID to identify the end point node which is the end point of each lane link. The road structure type represents a road structure type of each lane link. The road structure type is classified into, for example, a normal lane, a branch lane, a merging lane, a climbing lane, a bus lane, an HOV (High-Occupancy Vehicle) lane, or the like, in accordance with the road structure. The lane link shape represents a link shape of each lane link, though details thereof will be described later. The carriageway marking line information is data indicating information on a carriageway marking line of each lane, and includes the color type or the line type of the carriageway marking line such as a white point line, a white solid line, a yellow solid line, or the like, a pavement marking type such as a deceleration sign or the like, or the like. The control information indicates the traffic restrictions or the speed limit of each lane link. The lane type indicates a traveling direction determined for the lane, in which the vehicle should follow. The lane type includes a left turn lane, a right turn lane, a straight-ahead travel lane, a U-turn lane, a lane in which these lanes are combined, or the like. In the second preferred embodiment, the lane type is information on the above-described lane of the road.

The lane link shape includes the number of lane link shape interpolation points and lane link shape information.

The number of lane link shape interpolation points represents the number of lane link shape interpolation points which are vertices of the shape of each lane link that is represented by a polygonal line.

The lane link shape information includes shape coordinates, an altitude, a longitudinal slope, a cross slope, a radius of curvature, and a curvature. The shape coordinates are coordinates of the lane link shape interpolation points which are vertices of the polygonal line representing the shape of each lane link. The longitudinal slope is a slope from one lane link shape interpolation point to the next lane link shape interpolation point.

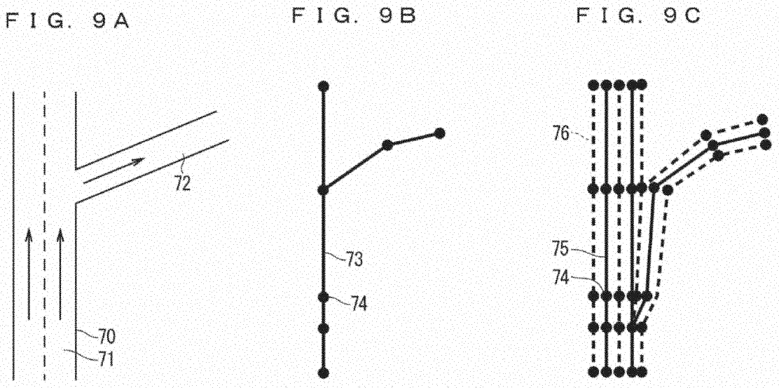

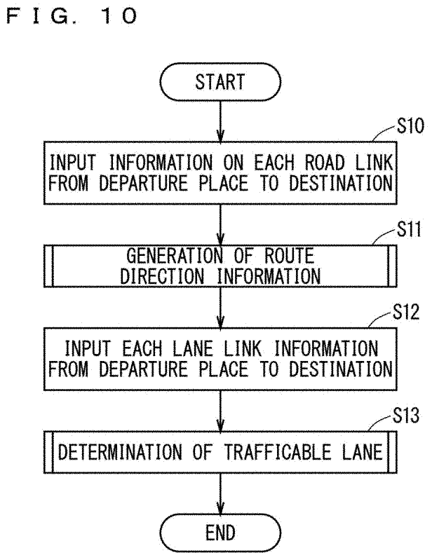

FIG. 9(a) is a view showing an exemplary planar structure of a road 70. The road 70 consists of two parallelly-placed lanes 71 and one branch lane 72. FIG. 9(b) is a view showing a road link 73 corresponding to the road 70 shown in FIG. 9(a). The road is represented by continuously placing the road links 73 each connecting two nodes 74. The road link 73 is placed at the center of the road. FIG. 9(c) is a view showing a lane link 75 corresponding to the road 70 shown in FIG. 9(a). Each of the lanes 71 constituting the road is represented by continuously placing the lane links 75 each connecting two nodes 74. Further, each of the lane links 75 is placed at the center sandwiched by two carriageway marking lines 76.

(Operation)

Next, a display control method performed by the display control device 101 and an operation of the navigation system will be described. Further, in the following operation, a case where the vehicle follows a traffic regulation determining the left-hand traffic in principle will be described. In another case where the vehicle follows a traffic regulation determining the right-hand traffic, representations of “left” and “right” are reversed.

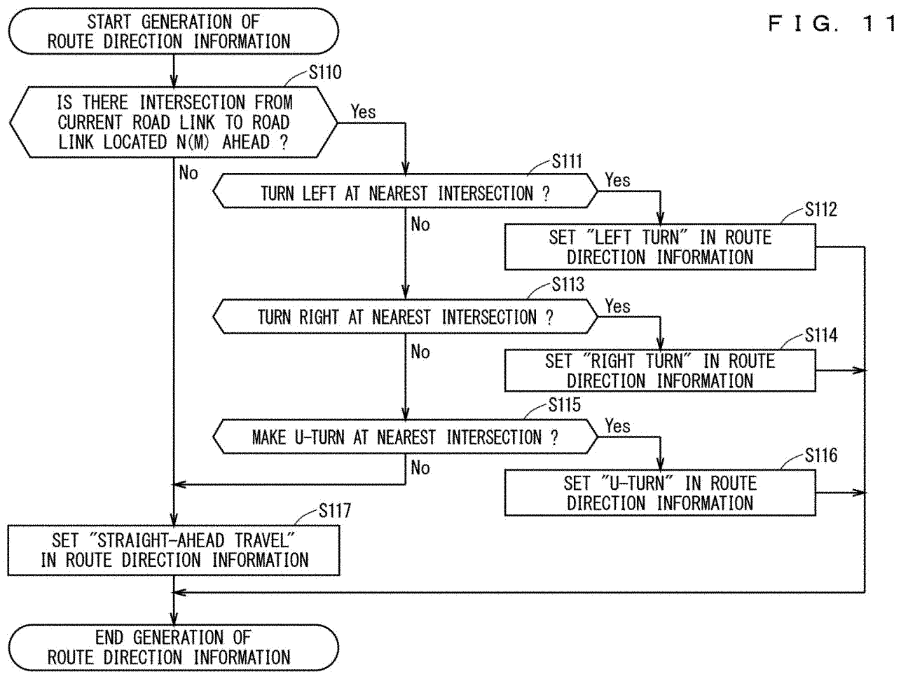

FIG. 10 is a flowchart showing an exemplary method of generating trafficable lane information.

In Step S10, the trafficable lane determination unit 1 receives information on each road link from a departure place to a destination, i.e., information on a route, from the route search unit 5. In other words, each road link from the departure place to the destination has been searched for in advance by the route search unit 5. The information on each road link is included in, for example, the map data acquired from the map data storage unit when the route search unit 5 searches for the route.

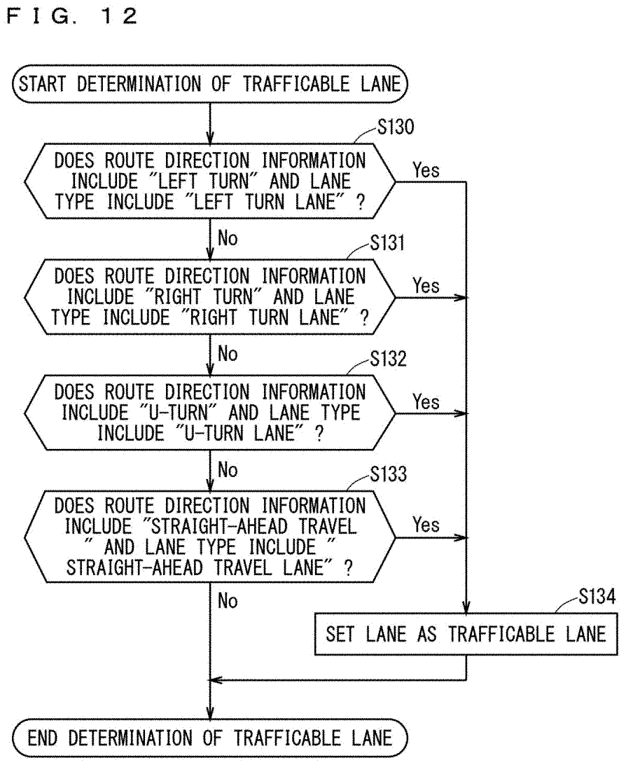

In Step S11, the trafficable lane determination unit 1 generates route direction information by using the information on each road link to the destination. Herein, the method of generating the route direction information is performed along the flowchart shown in FIG. 11. FIG. 11 is a flowchart showing an exemplary method of generating the route direction information.

In Step S110, it is determined whether or not there is an intersection from a current road link to a road link which is located N (m) ahead of the current road link. Herein, the current road link is one road link among a plurality of road links constituting the route from the departure place to the destination. Further, N is any number. When it is determined that there is an intersection, Step S111 is executed. When it is determined that there is not any intersection, Step S117 is executed.

In Step S111, it is determined whether to turn left at the nearest intersection in order to head for the destination. When it is determined to turn left, Step S112 is executed. When it is determined not to turn left, Step S113 is executed.

In Step S112, “left turn” is set in the route direction information and the generation of the route direction information is completed.

In Step S113, it is determined whether to turn right at the nearest intersection in order to head for the destination. When it is determined to turn right, Step S114 is executed. When it is determined not to turn right, Step S115 is executed.

In Step S114, “right turn” is set in the route direction information and the generation of the route direction information is completed.

In Step S115, it is determined whether to make a U-turn at the nearest intersection in order to head for the destination. When it is determined to make a U-turn, Step S116 is executed. When it is determined not to make a U-turn, Step S117 is executed.

In Step S116, “U-turn” is set in the route direction information and the generation of the route direction information is completed.

In Step S117, “straight-ahead travel” is set in the route direction information and the generation of the route direction information is completed.

After the generation of the route direction information is completed, Step S12 in FIG. 10 is executed.

In Step S12, the trafficable lane determination unit 1 receives each piece of lane link information corresponding to each road link from the departure place to the destination. Each piece of lane link information is acquired from, for example, the route to the destination or the map data, which is acquired in Step S10.

In Step S13, the trafficable lane determination unit 1 determines a trafficable lane. Herein, the method of determining the trafficable lane is performed along the flowchart shown in FIG. 12. FIG. 12 is a flowchart showing an exemplary method of determining the trafficable lane.

In Step S130, it is determined whether or not “left turn” is included in the route direction information and “left turn lane” is included in the lane type of the current lane link. When it is determined that both “left turn” and “left turn lane” are included, in Step S134, the “left turn lane” is set as the trafficable lane and the method of determining the trafficable lane is completed. When it is determined that one of “left turn” and “left turn lane” is not included, Step S131 is executed.

In Step S131, it is determined whether or not “right turn” is included in the route direction information and “right turn lane” is included in the lane type of the current lane link. When it is determined that both “right turn” and “right turn lane” are included, in Step S134, the “right turn lane” is set as the trafficable lane and the method of determining the trafficable lane is completed. When it is determined that one of “left turn” and “right turn lane” is not included, Step S132 is executed.

In Step S132, it is determined whether or not “U-turn” is included in the route direction information and “U-turn lane” is included in the lane type of the current lane link. When it is determined that both “U-turn” and “U-turn lane” are included, in Step S134, the “U-turn lane” is set as the trafficable lane and the method of determining the trafficable lane is completed. When it is determined that one of “U-turn” and “U-turn lane” is not included, Step S133 is executed.

In Step S133, it is determined whether or not “straight-ahead travel” is included in the route direction information and “straight-ahead travel lane” is included in the lane type of the current lane link. When it is determined that both “straight-ahead travel” and “straight-ahead travel lane” are included, in Step S134, the “straight-ahead travel lane” is set as the trafficable lane and the method of determining the trafficable lane is completed. When it is determined that one “straight-ahead travel” and “straight-ahead travel lane” is not included, the method of determining the trafficable lane is completed.

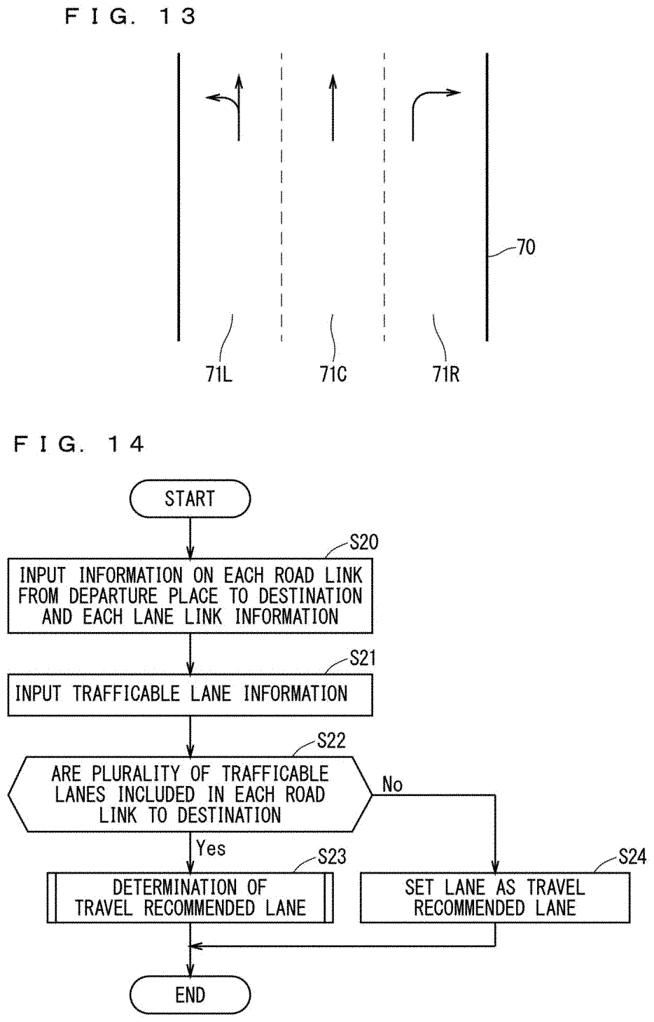

FIG. 13 is a schematic view showing the lane types and the road. When the condition (i) and the condition (ii) described below are satisfied, the trafficable lane determination unit 1 sets the lane 71L and the lane 71C as the trafficable lanes. The condition (i) is that the route direction information generated in Step S11 indicates “straight-ahead travel”. The condition (ii) is that the lane type acquired by the trafficable lane determination unit 1 in Step S12 includes the three lanes 71L, 71C, and 71R and the lane 71L is a “left turn or straight-ahead travel lane”, the lane 71C is a “straight-ahead travel lane”, and the lane 71R is a “right turn lane”.

Further, when the route direction information includes “left turn” ahead of the road shown in FIG. 13, the lane 71L and the lane 71C shown in FIG. 13 are lane changeable sections. The lane change section refers to a section in which the user can change the lane in accordance with the route direction information ahead of the road. In the present preferred embodiment, since a plurality of lanes are set as the trafficable lanes, the lane changeable section is automatically set by setting the trafficable lanes.

Through Step S13 including Steps S130 to S134 described above, the trafficable lane determination unit 1 determines the trafficable lanes on the basis of the lane type which is the information on the road included in the map data and the route to the destination of the vehicle. In the present preferred embodiment, the trafficable lane determination unit 1 determines and sets the trafficable lanes on all the routes, not only at a spot which is part of the routes from the departure place to the destination. By finishing the method of determining the trafficable lane in Step S13 of FIG. 10, the method of generating the trafficable lane information is completed.

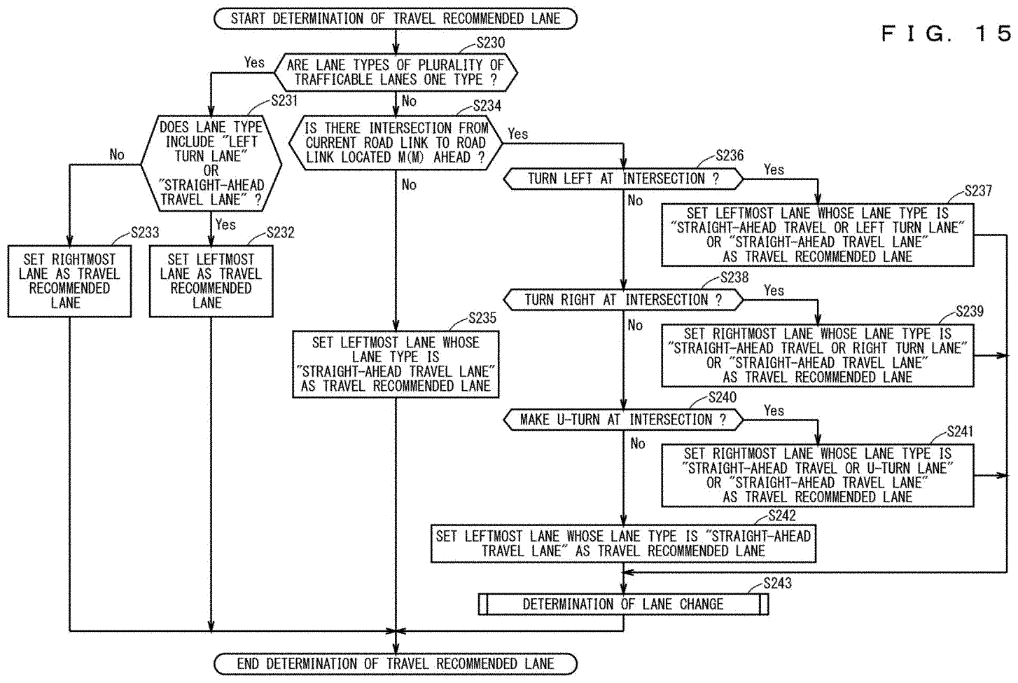

FIG. 14 is a flowchart showing an exemplary method of generating travel recommended lane information.

In Step S20, the travel recommended lane determination unit 6 acquires information on the route from the departure place to the destination which has been set in advance, i.e., on each road link and each piece of lane link information from the route search unit 5. When Step S20 is executed continuously after the method of generating the trafficable lane information shown in FIG. 10, the route to the destination or the map data which is acquired in Step S10 may be used.

In Step S21, the travel recommended lane determination unit 6 acquires the trafficable lane information generated by the method of generating the trafficable lane information shown in FIG. 10.

In Step S22, the travel recommended lane determination unit 6 determines whether or not each road link to the destination includes a plurality of trafficable lanes, on the basis of the trafficable lane information. When each road link includes a plurality of trafficable lanes, Step S23 is executed. When each road link does not include a plurality of trafficable lanes, i.e., when the trafficable lane is one lane, the one trafficable lane is set as the travel recommended lane in Step S24. After that, the method of generating the travel recommended lane information is completed.

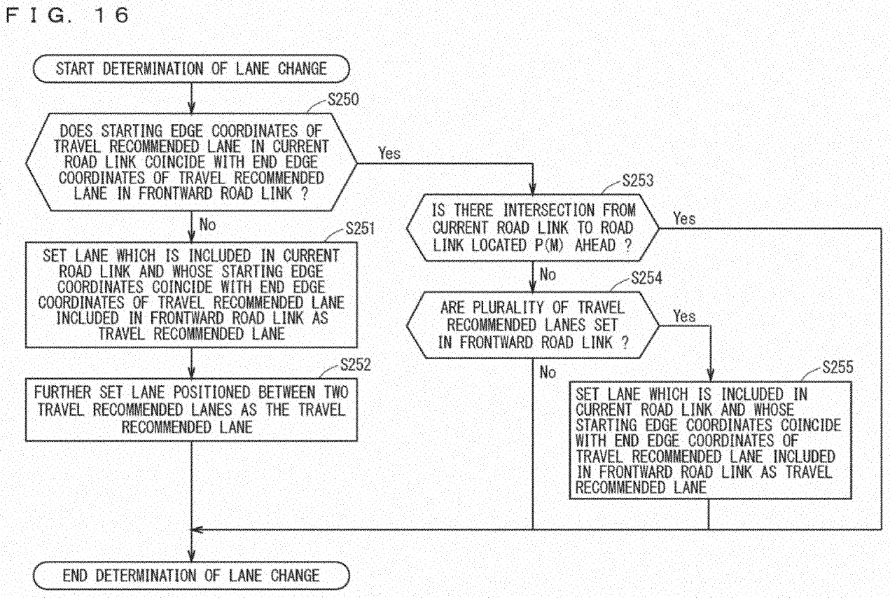

In Step S23, the travel recommended lane determination unit 6 determines the travel recommended lane. Herein, the method of determining the travel recommended lane is performed along the flowchart shown in FIG. 15. FIG. 15 is a flowchart showing an exemplary method of determining the travel recommended lane.

In Step S230, the travel recommended lane determination unit 6 determines whether or not the lane types of the plurality of trafficable lanes in the current road link are one type. When the lane types are same, Step S231 is executed. When the lane types are not one type, Step S234 is executed.

In Step S231, the travel recommended lane determination unit 6 determines whether or not the lane type includes “left turn lane” or “straight-ahead travel lane”. When it is determined that the lane type includes “left turn lane” or “straight-ahead travel lane”, Step S232 is executed. When it is determined that the lane type does not include “left turn lane” and “straight-ahead travel lane”, Step S233 is executed.

In Step S232, the travel recommended lane determination unit 6 sets the lane positioned leftmost as the travel recommended lane. After that, the method of determining the travel recommended lane is completed.

In Step S233, the travel recommended lane determination unit 6 sets the lane positioned rightmost as the travel recommended lane. After that, the method of determining the travel recommended lane is completed.

In Step S234, the travel recommended lane determination unit 6 determines whether or not there is an intersection from the current road link to a road link which is located M (m) ahead of the current road link. Further, M is any number. When it is determined that there is not any intersection, Step S235 is executed. When it is determined that there is an intersection, Step S236 is executed.

In Step S235, the travel recommended lane determination unit 6 sets a lane whose lane type is “straight-ahead travel lane” and which is positioned leftmost, as the travel recommended lane, among the plurality of trafficable lanes. After Step S235, the method of determining the travel recommended lane is completed.

In Step S236, the travel recommended lane determination unit 6 determines whether to turn left at the intersection. When it is determined to turn left, Step S237 is executed. When it is determined not to turn left, Step S238 is executed.

In Step S237, the travel recommended lane determination unit 6 sets a lane whose lane type is “straight-ahead travel or left turn lane” or “straight-ahead travel lane” and which is positioned leftmost, as the travel recommended lane, among the plurality of trafficable lanes. After Step S237, Step S243 is executed.

In Step S238, the travel recommended lane determination unit 6 determines whether to turn right at the intersection. When it is determined to turn right, Step S239 is executed. When it is determined not to turn right, Step S240 is executed.

In Step S239, the travel recommended lane determination unit 6 sets a lane whose lane type is “straight-ahead travel or right turn lane” or “straight-ahead travel lane” and which is positioned rightmost, as the travel recommended lane, among the plurality of trafficable lanes. After Step S239, Step S243 is executed.

In Step S240, the travel recommended lane determination unit 6 determines whether to make a U-turn at the intersection. When it is determined to make a U-turn, Step S241 is executed. When it is determined not to make a U-turn, Step S242 is executed.

In Step S241, the travel recommended lane determination unit 6 sets a lane whose lane type is “straight-ahead travel or U-turn lane” or “straight-ahead travel lane” and which is positioned rightmost, as the travel recommended lane, among the plurality of trafficable lanes. After Step S241, Step S243 is executed.

In Step S242, the travel recommended lane determination unit 6 sets a lane whose lane type is “straight-ahead travel lane” and which is positioned leftmost, as the travel recommended lane, among the plurality of trafficable lanes. After Step S242, Step S243 is executed.

In Step S243, the lane change determination unit 7 determines the lane change and sets a lane change recommendation section in a place requiring the lane change. Herein, the method of determining the lane change is performed along the flowchart shown in FIG. 16. FIG. 16 is a flowchart showing an exemplary method of determining the lane change.

In Step S250, the lane change determination unit 7 determines whether or not starting edge coordinates of the travel recommended lane in the current road link coincide with end edge coordinates of the travel recommended lane in a road link positioned on the frontward side of the current road link. When it is determined that the starting edge coordinates do not coincide with the end edge coordinates, Step S251 is executed. When it is determined that the starting edge coordinates coincide with the end edge coordinates, Step S253 is executed.

In Step S251, the lane change determination unit 7 sets a lane which is included in the current road link and whose starting edge coordinates coincide with the end edge coordinates of the travel recommended lane included in the road link on the frontward side, as the travel recommended lane.

In Step S252, the lane change determination unit 7 further sets a lane which is positioned between two travel recommended lanes in the current road link, i.e., a lane in parallel therewith, as the travel recommended lane. After Step S252, the method of determining the lane change is completed.

In Step S253, the lane change determination unit 7 determines whether or not there is an intersection from the current road link to a road link which is located P (m) ahead of the current road link. Herein, P<M. When it is determined that there is not any intersection, Step S254 is executed. When it is determined that there is an intersection, the method of determining the lane change is completed.

In Step S254, the lane change determination unit 7 determines whether or not a plurality of travel recommended lanes are set in the road link on the frontward side. When it is determined that a plurality of travel recommended lanes are not set, the method of determining the lane change is completed. When it is determined that a plurality of travel recommended lanes are set, Step S255 is executed.

In Step S255, the lane change determination unit 7 sets a lane whose starting edge coordinates coincide with the end edge coordinates of the travel recommended lane included in the road link on the frontward side, as the travel recommended lane, among the plurality of lanes included in the current road link. After Step S255, the method of determining the lane change is completed.

Thus, through Step S243 including Steps S250 to S255 shown in FIG. 16, the lane change determination unit 7 determines whether or not a place requiring the lane change is included. Then, set is the lane change recommendation section which consists of a plurality of travel recommended lanes having portions adjacent to one another in the place requiring the lane change. The lane change recommendation section is set to have a different length, depending on the number of lanes constituting the road, the road type (a general road or an expressway), a traffic jam situation, or the like. On a road having a large number of lanes, for example, the lane change recommendation section is set long. Further, on the general road, for example, the lane change recommendation section is set shorter than that on the expressway.

By finishing Step S243 shown in FIG. 15, the method of determining the travel recommended lane is completed.

Thus, in Step S23 including Steps S230 to S243, the travel recommended lane determination unit 6 determines the travel recommended lane on which traveling is recommended, from the plurality of trafficable lanes determined by the trafficable lane determination unit 1, on the basis of lane type which is the information on the road included in the map data and the route to the destination of the vehicle. In the present preferred embodiment, the travel recommended lane determination unit 6 determines and sets the travel recommended lane on all the routes from the departure place to the destination.

By finishing the method of determining the travel recommended lane in Step S23 of FIG. 14, the method of generating the travel recommended lane information is completed.

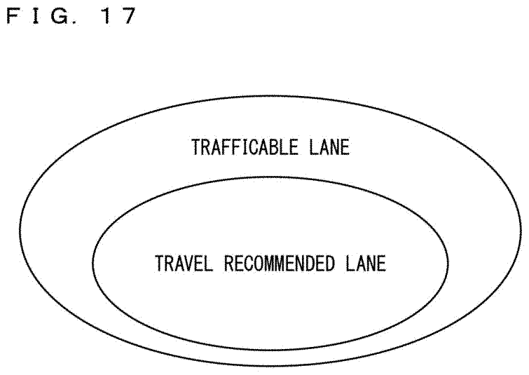

FIG. 17 is a view showing an inclusion relation of the trafficable lane and the travel recommended lane described above. The travel recommended lane is included in the trafficable lane. A road having two lanes, which consists of one trafficable lane and one travel recommended lane, for example, is also a road consisting of a plurality of trafficable lanes. Further, though not shown, the lane change recommendation section is included in the travel recommended lane.

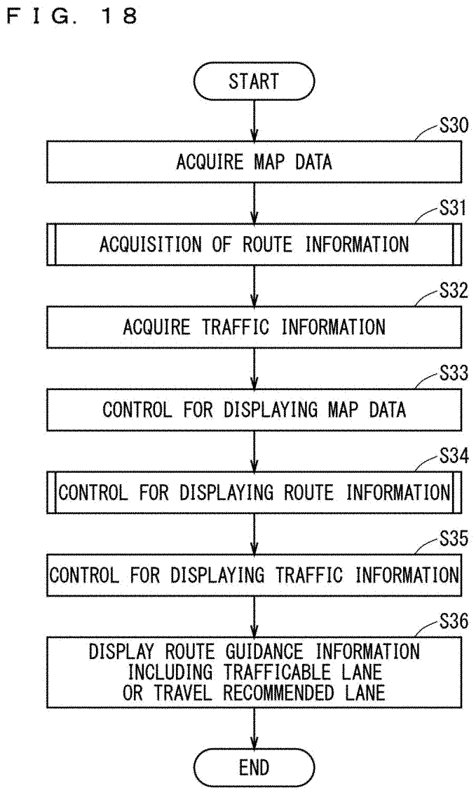

Next, a method of displaying the route guidance information on the display unit will be described. FIG. 18 is a flowchart showing an exemplary display control method of the route guidance information.

In Step S30, the system control unit 2 acquires the map data form the map data storage unit 21.

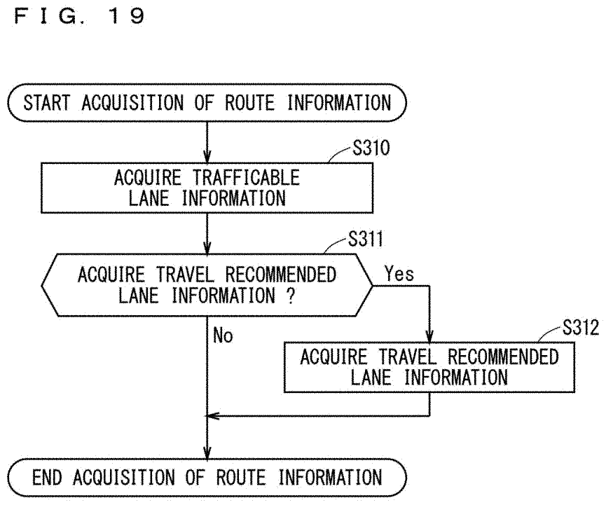

In Step S31, the system control unit 2 acquires the route information to the destination, i.e., the trafficable lane information and the travel recommended lane information. Herein, the method of acquiring the route information is performed along the flowchart shown in FIG. 19. FIG. 19 is a flowchart showing an exemplary method of acquiring the route information.

In Step S310, the system control unit 2 acquires the trafficable lane information from the trafficable lane determination unit 1. The trafficable lane information is the information generated by the method of generating the trafficable lane information shown in FIG. 10.

In Step S311, the system control unit 2 determines whether to acquire the travel recommended lane information. When it is determined to acquire the travel recommended lane information, Step S312 is executed. When it is determined not to acquire the travel recommended lane information, the method of acquiring the route information is completed.

In Step S312, the system control unit 2 acquires the travel recommended lane information from the travel recommended lane determination unit 6. The travel recommended lane information is the information generated by the method of generating the travel recommended lane information shown in FIG. 14. Further, the selection on whether to acquire the travel recommended lane information is, for example, inputted in advance by the user through the operation unit 26 or the audio input unit 27. When the user selects to display only the trafficable lane on the display unit 20, for example, Step S312 is not executed.

Thus, the method of acquiring the route information is completed, and next, Step S32 shown in FIG. 18 is executed.

In Step S32, the system control unit 2 acquires traffic information such as traffic jam information or the like from the traffic information acquisition unit 25. Further, in Step S32, the traffic information to be acquired is only one example, but the system control unit 2 may acquire any data to be displayed on the display unit 20, other than the map data or the route information, not limited to the traffic information, from an appropriate function unit.

In Step S33, the system control unit 2 controls the display output control unit 10 in order to display the map data acquired in Step S30 on the display unit 20. The display output control unit 10 generates the display signal to display the map data, on the basis of the control.

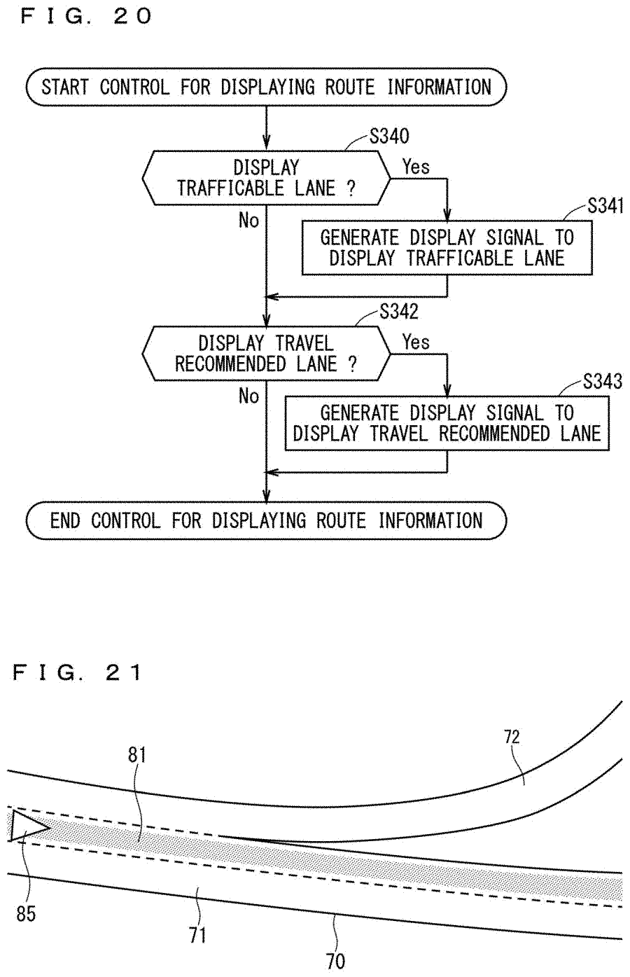

In Step S34, the system control unit 2 controls the display output control unit 10 in order to display the route information acquired in Step S31 on the display unit 20. The display output control unit 10 generates the display signal to display the trafficable lane or the travel recommended lane, on the basis of the control. Herein, the control method for displaying the trafficable lane or the travel recommended lane is performed along the flowchart shown in FIG. 20. FIG. 20 is a flowchart showing an exemplary control method for displaying the route information.

In Step S340, the system control unit 2 determines whether to display the trafficable lane on the display unit 20. The selection on whether to display the trafficable lane is, for example, inputted in advance by the user through the operation unit 26 or the audio input unit 27. When the trafficable lane should be displayed, Step S341 is executed. When the trafficable lane should not be displayed, Step S342 is executed.

In Step S341, the system control unit 2 controls the display output control unit 10 in order to display the plurality of trafficable lanes. The display output control unit 10 generates the display signal to display the plurality of trafficable lanes, on the basis of the control.

In Step S342, the system control unit 2 determines whether to display the travel recommended lane on the display unit 20. The selection on whether to display the travel recommended lane is, for example, inputted in advance by the user through the operation unit 26 or the audio input unit 27. When the travel recommended lane should be displayed, Step S343 is executed. When the travel recommended lane should not be displayed, the display control method for displaying the trafficable lane or the travel recommended lane is completed.

In Step S343, the system control unit 2 controls the display output control unit 10 in order to display the travel recommended lane on the display unit 20. The display output control unit 10 generates the display signal to display the travel recommended lane, on the basis of the control.

After the control method for displaying the route information is completed, Step S35 shown in FIG. 18 is executed. In Step S35, the system control unit 2 controls the display output control unit 10 in order to display the traffic information acquired in Step S32 on the display unit 20. The display output control unit 10 generates the display signal to display the traffic information, on the basis of the control. Further, in a case where the system control unit 2 acquires data other than the map data or the route information in Step S32, the display output control unit 10 generates the display signal to display the other data.

In Step S36, the display unit 20 accepts each display signal from the display output control unit 10 and displays the route guidance information including the trafficable lane or the travel recommended lane, or the like, on the map. The trafficable lane or the travel recommended lane to be displayed are displayed on all the routes from the departure place to the destination. The user can check the trafficable lane or the travel recommended lane at any spots from the departure place to the destination. The user can check, for example, the trafficable lane or the travel recommended lane at a spot away from the vehicle which the user drives. Further, in Step S34, it is possible to switch between being necessary to display the trafficable lane or the travel recommended lane and being not necessary. The user can display the trafficable lane, display only the travel recommended lane, or switch between displaying the trafficable lane and displaying only the travel recommended lane, even during driving of the vehicle, by setting the navigation system.

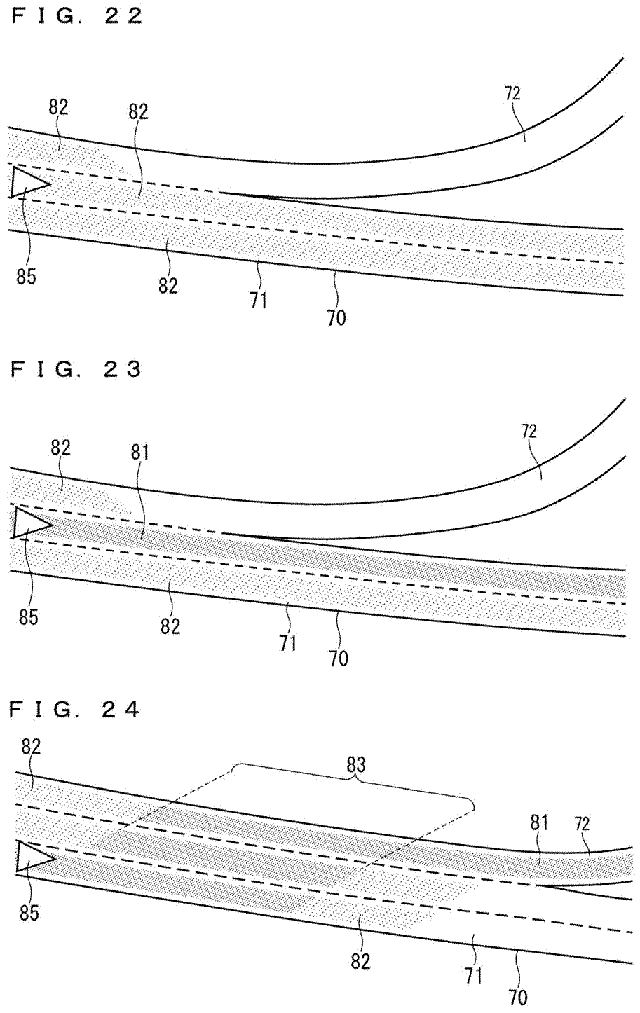

FIG. 21 is a view showing an exemplary map displayed on the display unit in the underlying technology of the present invention. FIGS. 22 and 23 are views each showing an exemplary map displayed on the display unit 20 in accordance with the second preferred embodiment. In each figure, the destination is located in the right direction of the figure and the vehicle travels from the left side to the right side of the figure. The road 70 consists of three lanes 71, and the center lane and the lane positioned on the right side with respect to the traveling direction are straight-ahead travel lane and the lane positioned on the left side with respect to the traveling direction is a branch lane 72 which branches to the left direction. In each figure, a current position 85 of the vehicle is positioned on the frontward side of the branch lane 72 and on the center lane.

In the map of FIG. 21, only the travel recommended lane 81 is displayed on the center lane among the three lanes 71. In other words, the route to the destination is uniquely determined. Such a display gives the user an impression that the user should travel on only one lane. As a result, a large number of vehicles concentrate on the one lane and this causes a traffic jam.

In the map of FIG. 22, a plurality of trafficable lanes 82 are displayed on the road 70. In other words, FIG. 22 corresponds to a result of the control to display the trafficable lanes 82, which is performed in Step S34 of FIG. 18. Until the frontward side of the branch lane 72, all the lanes 71 are displayed as the trafficable lanes 82. The lane positioned leftmost with respect to the traveling direction branches to a direction different from that of the destination by the branch lane 72. For this reason, the trafficable lane 82 is displayed until the frontward side of the branch lane 72. Ahead of the branch lane 72, the two lanes 71 positioned at the center and on the right side are displayed as the trafficable lanes 82. With such a display, the navigation system can prompt the user to change the lane. Further, by displaying the plurality of trafficable lanes 82, the navigation system provides a plurality of options as to the lane on which the user will travel. As a result, there is an increased possibility that a plurality of vehicles may travel, being distributed to the plurality of trafficable lanes 82, and occurrence of a traffic jam or the like can be reduced.

In the map of FIG. 23, displayed are a plurality of trafficable lanes 82 and one travel recommended lane 81. In other words, the map shown in FIG. 23 corresponds to a result of the control to display the trafficable lanes 82 and the travel recommended lane 81, which is performed in Step S34 of FIG. 18. Among the three lanes 71, the lane positioned at the center is displayed as the travel recommended lane 81. Further, like in FIG. 22, the trafficable lanes 82 are displayed on part of the lane positioned on the left side with respect to the traveling direction and the lane positioned on the right side. Herein, the display control device 101 causes the display unit 20 to display thereon the travel recommended lane 81 and the trafficable lanes 82 in different visibility states. In FIG. 23, the travel recommended lane 81 and the trafficable lanes 82 are displayed in different colors. In other words, the navigation system provides the information on the travel recommended lane 81 on which the user is recommended to travel while providing the options to travel other lanes. With this operation, the navigation system can reduce a traffic jam or the like. Further, the navigation system provides the user with the degree of freedom in traveling, to thereby resolve the stress of the user which is caused by limiting the lane on which the user can travel to one.

FIG. 24 is a view showing an exemplary map including a lane change recommendation section 83 displayed on the display unit 20 in accordance with the second preferred embodiment. The structure of the road 70 is the same as that of the road in any one of FIGS. 21 to 23. The destination is, however, located in a direction in which the vehicle travels through the branch lane 72. In FIG. 24, the lane change recommendation section 83 is displayed on the frontward side of the branch lane 72. In other words, the map shown in FIG. 24 corresponds to a result of the control to display the lane change recommendation section 83, which is set by the method of determining the lane change shown in FIG. 16.

The lane change recommendation section 83 consists of three travel recommended lanes 81 and the travel recommended lanes 81 have portions adjacent to one another. By displaying the lane change recommendation section 83, there is a reduced possibility that a plurality of vehicles may change the lane while passing through the same lane at the same spot. This reduces, for example, occurrence of a traffic jam in the vicinity of the branch lane 72. The lane change recommendation section is displayed to have a different length, depending on the number of lanes 71 constituting the road 70, the road type, a traffic jam situation, or the like. Further, before or after the lane change recommendation section 83, a lane changeable section consisting of a plurality of trafficable lanes 82 having portions adjacent to one another may be displayed. In FIG. 24, for example, ahead of the end edge of the lane change recommendation section 83, two trafficable lanes 82 running in parallel are displayed. This is a lane changeable section.

The display control device 101 can display the travel recommended lane 81 and the trafficable lanes 82 as shown in FIGS. 22 to 24 on all the routes, not only on part of the routes to the destination, such as the intersection, the branch lane, or the like. Further, the display control device 101 can enlargedly display the map and display the travel recommended lane 81 or the trafficable lanes 82 thereon at any spot in the route to the destination. Furthermore, the display control device 101 can switch between the display of the trafficable lanes 82 and the display of the travel recommended lane 81 on the display unit 20 even during driving of the vehicle. Since the display control device 101 determines the travel recommended lane 81 and the trafficable lanes 82 by using the route which has been already searched for by the route search unit 5, it is possible to reduce the system load, as compared with a display method accompanied by the route search.

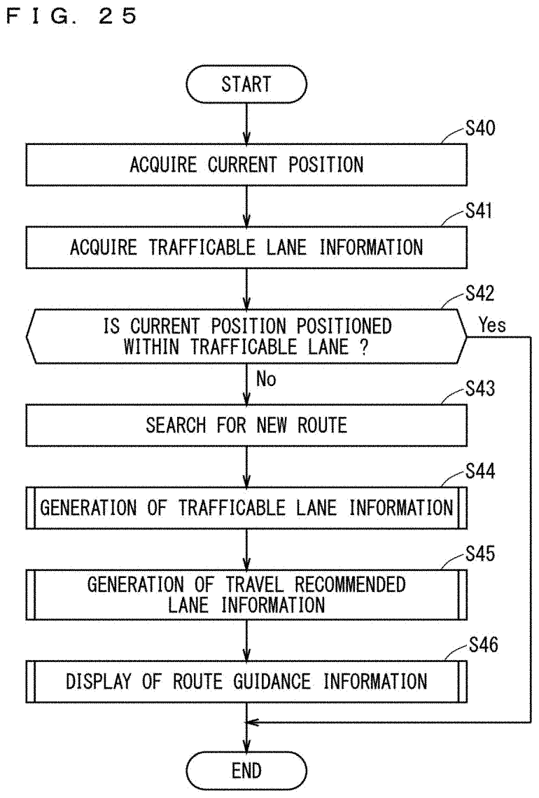

Next, respective operations of the display control device 101 and the navigation system in a case where the vehicle deviates from the trafficable lane will be described. In the case where the vehicle deviates from the trafficable lane, the display control device 101 re-searches for the route to the destination and redetermines the trafficable lane or the travel recommended lane. FIG. 25 is a flowchart showing an exemplary method of re-searching for the route and redisplaying the trafficable lane or the travel recommended lane.

In Step S40, the current position acquisition unit 3 acquires the current position of the vehicle from the current position detection unit 23 and outputs the current position to the system control unit 2.

In Step S41, the system control unit 2 acquires the trafficable lane information.

In Step S42, the traffic lane determination unit 9 determines whether or not the current position of the vehicle is positioned within the trafficable lane. When it is determined that the current position is not positioned within the trafficable lane, Step S43 is executed. When it is determined that the current position is positioned within the trafficable lane, the method of re-searching for and redisplaying the route is completed.

In Step S43, the route search unit 5 searches for a new route from the current position to the destination. At that time, the route search unit 5 acquires the map data from the current position to the destination from the map data storage unit 21 and uses this map data for the search.

In Step S44, the trafficable lane information is generated. This method is the same as that shown in FIG. 10. Through Step S44, the trafficable lane in the new route is determined and set.

In Step S45, the travel recommended lane information is generated. This method is the same as that shown in FIG. 14. Through Step S45, the travel recommended lane in the new route is determined and set.

In Step S46, new route guidance information is displayed. This method is the same as that shown in FIG. 18.

Through the above-described steps, in the case where the vehicle deviates from the trafficable lane, the navigation system re-searches for a new route to the destination and displays, on the display unit 20, the trafficable lane or the travel recommended lane in the route which is re-searched for. On the other hand, in a case where the vehicle is positioned within the trafficable lane or the travel recommended lane, the search for a new route is not performed. In a case, for example, where the vehicle changes the lane from the travel recommended lane to the trafficable lane, or in the reverse case, the route search is not performed.

Further, when the vehicle changes the lane from the travel recommended lane to the trafficable lane, there is no case where the trafficable lane to which the lane is changed is switched to the travel recommended lane, to be redrawn and displayed. In such a case, the display control device 101 determines that the user intentionally changes the lane to the trafficable lane. Then, the display control device 101 does not switch to the display of the travel recommended lane also in order to provide the user with the information indicating that the lane on which the vehicle currently travels is the trafficable lane.

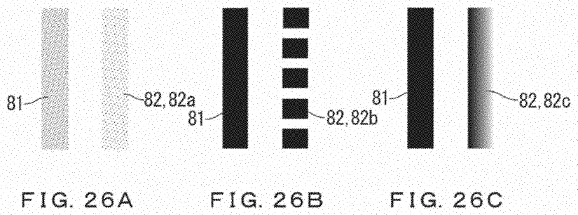

FIGS. 26(a) to 26(c) are views showing exemplary display states of the travel recommended lane 81 and the trafficable lane 82 which the display control device 101 displays on the display unit 20. The information that the travel recommended lane 81 has is different from the information that the trafficable lane 82 has. Then, the display control device 101 causes the display unit 20 to display thereon the travel recommended lane 81 and the trafficable lane 82 in different visibility states. In FIG. 26(a), the travel recommended lane 81 and the trafficable lane 82a are displayed in different colors. In FIG. 26(b), the travel recommended lane 81 and the trafficable lane 82b are displayed in different patterns. In FIG. 26(c), the travel recommended lane 81 is displayed by filling the lane on the map and the trafficable lane 82c is displayed by gradating the lane on the map. In any case, the display control device 101 causes the display unit 20 to display thereon each lane in a visibility state corresponding to the contour of the lane displayed on the map.

The display control device 101 causes the display unit 20 to display thereon the travel recommended lane 81 and the trafficable lane 82 in different visibility states, to thereby provide the user with the information indicating that the travel recommended lane 81 and the trafficable lane 82 are routes having different information. As a result, the user can easily judge the difference between the travel recommended lane 81 and the trafficable lane 82.

Further, depending on the destination to be set or a point of passage to the destination, there are some cases where a route going along the same road on the map a plurality of times is provided. In this case, the display control device 101 may display the travel recommended lane 81 and the trafficable lane 82 in different display states between the first-time passage and the second-time or later passage of the vehicle. The user can thereby recognize that he has once traveled the route.

The above-described display control device 101 has been described as an exemplary configuration included in the navigation system mounted on the vehicle. The display control device 101 can be applied to a system configured by combining, as appropriate, a navigation device, a communication terminal, a server, and functions of applications to be installed therein. Herein, the navigation device includes, for example, a PND (Portable Navigation Device) or the like. The communication terminal includes, for example, a portable terminal such as a cellular phone, a smartphone, a tablet, or the like. The functions or the constituent elements of the display control device 101 may be arranged dispersedly in these devices constituting the navigation system or may be arranged collectively in any one device.

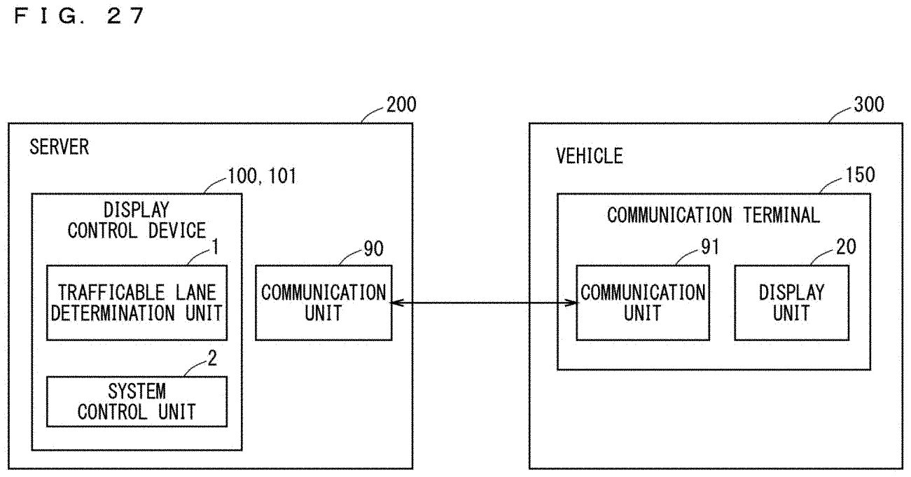

FIG. 27 is a block diagram showing another exemplary constitution of the display control device and the navigation system. In the navigation system of FIG. 27, the display control device 100 or the display control device 101 is provided in a server 200. The server 200 is provided with a communication unit 90 besides the display control device. A communication terminal 150 is set up in a vehicle 300, and the communication terminal 150 is provided with a communication unit 91 and the display unit 20.

The display control device 100 or 101 is capable of performing wireless communication from the communication unit 90 to the communication unit 91 of the communication terminal 150 via a network. In other words, the display control device 100 or 101 controls the display of the display unit 20 via the network. Since the display control device 100 or 101 is provided in the server 200, the configuration of an in-vehicle device including the display unit 20 or the like can be simplified.

### Effects

Summarizing the above description, the display control device 101 of the present preferred embodiment is a display control device 101 for causing the display unit 20 which is movable together with the vehicle to display thereon the lane on which the vehicle can travel, and includes the trafficable lane determination unit 1 for determining one or more trafficable lanes 82 which are lanes on which the vehicle can travel on the basis of the information on the lane of the road and the route to the destination of the vehicle and the control unit (the system control unit 2) for causing the display unit 20 to display thereon the plurality of trafficable lanes 82 determined by the trafficable lane determination unit 1, with respect to all lanes included in the road to be displayed on the display unit 20.

The display control device 101 is capable of displaying the plurality of trafficable lanes 82 on which the vehicle can travel on the map showing the route to the destination and provides a plurality of options as to the lane on which the vehicle travels. Especially, the plurality of trafficable lanes are displayed in accordance with the distance to the intersection or the branch/merging point ahead or the information thereof. As a result, there is an increased possibility that a plurality of vehicles traveling in the same direction may travel, being distributed to the plurality of trafficable lanes 82, and occurrence of a traffic jam or the like can be reduced. Further, the display control device 101 uses the information on the route to the destination, which has been already searched for, to determine and display the trafficable lanes 82. For this reason, the display control device 101 can display the trafficable lanes 82 on all the routes, not only at a spot which is part of the routes to the destination, such as the intersection, the branch lane, the merging lane, or the like. This is convenient since the user can check the route for each lane at any spot. Furthermore, the display control device 101 can reduce the system load, as compared with a display method accompanied by the route search.

Further, the display control device 101 can enlargedly display the map and display the trafficable lanes 82 thereon at any spot in the route to the destination. The user can check the trafficable lanes 82 at any spot. The user can check, for example, the trafficable lane 82 at a spot away from the vehicle which the user drives. The display control device 101 provides the user with the degree of freedom in traveling, to thereby resolve the stress of the user which is caused by limiting the lane on which the user can travel to one.

The display control device 101 further includes the travel recommended lane determination unit 6 for determining the travel recommended lane 81 included in the one or more trafficable lanes 82 determined by the trafficable lane determination unit 1 on the basis of the information on the lane of the road and the route to the destination of the vehicle. The system control unit 2 causes the display unit 20 to display thereon the travel recommended lane 81 determined by the travel recommended lane determination unit 6 with respect to at least one lane included in the road to be displayed on the display unit 20.

With such a configuration, the display control device 101 displays the travel recommended lane 81 and the trafficable lanes 82 at any spot from the departure place to the destination, not only at the intersection, the branch point, or the merging point. The display control device 101 provides the user with the information on the lane on which the user can travel, other than the travel recommended lane 81. With this operation, there is an increased possibility that a plurality of vehicles traveling in the same direction may travel, being distributed to the plurality of trafficable lanes 82 and the travel recommended lane 81, and occurrence of a traffic jam or the like can be reduced. Further, the display control device 101 can switch between the display of the trafficable lanes 82 and the display of the travel recommended lane 81 even during driving of the vehicle. The display control device 101 provides the user with the degree of freedom in traveling, to thereby resolve the stress of the user which is caused by limiting the lane on which the user can travel to one. Further, since the trafficable lane 82 and the travel recommended lane 81 are displayed for each lane, it becomes easier for the user to intuitively recognize the trafficable lane. Furthermore, since the display control device 101 determines and sets the travel recommended lane 81 for the route to the destination which has been searched for in advance, the load of the display control device 101 is reduced.

The display control device 101 further includes the lane change determination unit 7 for determining whether or not the travel recommended lane 81 constituting the route to the destination includes a place requiring the lane change. The system control unit 2 causes the display unit 20 to display thereon the lane change recommendation section 83 consisting of a plurality of travel recommended lanes 81 having portions adjacent to one another in the place requiring the lane change on the basis of the result of the lane change determination unit 7.

With such a configuration, the display control device 101 reduces the possibility that a plurality of vehicles change the lane at the same spot. This reduces occurrence of a traffic jam at the intersection, the branch or merging point.

The display control device 101 further includes the current position acquisition unit 3 for acquiring the current position of the vehicle, the traffic lane determination unit 9 for determining whether or not the current position of the vehicle is positioned within the trafficable lane 82, and the route search unit 5 for searching for a new route from the current position to the destination on the basis of a determination result obtained by the traffic lane determination unit, which indicates that the current position is not positioned within the trafficable lane 82.

With such a configuration, since the display control device 101 searches for a new route only when the vehicle deviates from the trafficable lane 82, it is possible to reduce the load of the whole system.

In the display control device 101, the system control unit 2 causes the display unit 20 to display thereon the trafficable lane 82 and the travel recommended lane 81 in different visibility states.

With such a configuration, the display control device 101 informs the user that the travel recommended lane 81 and the trafficable lane 82 are mutes having different information. As a result, the user can easily judge the difference between the travel recommended lane 81 and the trafficable lane 82.

Further, the display control method of the present preferred embodiment is a display control method for causing the display unit 20 which is movable together with the vehicle to display thereon the lane on which the vehicle can travel, and includes the step of determining one or more trafficable lanes 82 which are lanes on which the vehicle can travel on the basis of information on the lane of the road and the route to the destination of the vehicle and the step of causing the display unit 20 to display thereon the plurality of trafficable lanes 82 each determined to be the trafficable lane, with respect to all lanes included in the road to be displayed on the display unit 20.

With the above-described configuration, by the display control method performed by the display control device 101, it is possible to display the plurality of trafficable lanes 82 on which the vehicle can travel, on the map showing the route to the destination and provide a plurality of options as to the lane on which the vehicle can travel. As a result, there is an increased possibility that a plurality of vehicles traveling in the same direction may travel, being distributed to the plurality of trafficable lanes 82, and occurrence of a traffic jam or the like can be reduced. Further, the display control device 101 can display the trafficable lanes 82 on all the routes, not only at a spot which is part of the routes to the destination, such as the intersection, the branch lane, the merging lane, or the like. Furthermore, the display control device 101 can enlargedly display the map and display the trafficable lanes 82 thereon at any spot in the route to the destination. The user can check the trafficable lanes 82 at any spot. The user can check, for example, the trafficable lane 82 at a spot away from the vehicle which the user drives. The display control device 101 provides the user with the degree of freedom in traveling, to thereby resolve the stress of the user which is caused by limiting the lane on which the user can travel to one. Further, the display control device 101 can reduce the system load, as compared with a display method accompanied by the route search.

In the present invention, the preferred embodiments may be freely combined, or may be changed or omitted as appropriate, without departing from the scope of the invention. While the invention has been shown and described in detail, the foregoing description is in all aspects illustrative and not restrictive. It is therefore understood that numerous modifications and variations can be devised without departing from the scope of the invention.

### Explanation of Reference Signs

1 trafficable lane determination unit, 2 system control unit, 3 current position acquisition unit, 7 route search unit, 9 traffic lane determination unit, 11 travel recommended lane determination unit, 12 lane change determination unit, 20 display unit, 81 travel recommended lane, 82 trafficable lane, 85 current position, 100 display control device, 101 display control device, 300 vehicle

1. A display control device for causing a display unit which is movable together with a vehicle to display thereon a lane on which the vehicle can travel, the display control device comprising:
a processor to execute a program; and
a memory to store the program which, when executed by the processor, causes the processor to perform processes of,
determining one or more trafficable lanes which are lanes on which the vehicle can travel on the basis of information on a lane of a road and a route to a destination of the vehicle, and
causing the display unit to display thereon the plurality of trafficable lanes with respect to all lanes included in a road to be displayed on the display unit.

2. The display control device according to claim 1, wherein the processes performed by the processor further includes
determining a travel recommended lane included in the one or more trafficable lane on the basis of the information on the lane of the road and the route to the destination of the vehicle, and
causing the display unit to display thereon the travel recommended lane with respect to at least one lane included in the road to be displayed on the display unit.

3. The display control device according to claim 2, wherein the processes performed by the processor further includes
determining whether or not the travel recommended lane constituting the route to the destination includes a place requiring a lane change, and
causing the display unit to display thereon a lane change recommendation section consisting of a plurality of travel recommended lanes having portions adjacent to one another in the place requiring the lane change on the basis of a determination result whether or not the travel recommended lane includes the place requiring the lane change.

4. The display control device according to claim 1, wherein the processes performed by the processor further includes
acquiring a current position of the vehicle
determining whether or not the current position of the vehicle is positioned within the trafficable lane, and
searching for a new route from the current position to the destination on the basis of a determination result indicating that the current position is not positioned within the trafficable lane.

5. The display control device according to claim 2, wherein the processes performed by the processor further includes
causing the display unit to display thereon the trafficable lane and the travel recommended lane in different visibility states.

6. A display control method for causing a display unit which is movable together with a vehicle to display thereon a lane on which the vehicle can travel, the display control method comprising:
determining one or more trafficable lanes which are lanes on which the vehicle can travel on the basis of information on a lane of a road and a route to a destination of the vehicle; and
causing the display unit to display thereon the plurality of trafficable lanes each determined to be the trafficable lane, with respect to all lanes included in a road to be displayed on the display unit.
